(19) United States
(12) Patent Application Publication
(10) Pub. No.: US 2012/0208048 A1
(43) Pub. Date: Aug. 16, 2012

(54) BATTERIES FOR POWER TOOLS AND METHODS OF MOUNTING BATTERY TERMINALS TO BATTERY HOUSINGS

(75) Inventors: Hironori OGURA, Anjo-shi (JP); Hideyuki TAGA, Anjo-shi (JP); Hidekazu HAYASHI, Anjo-shi (JP)

(73) Assignee: MAKITA CORPORATION, Anjo-shi (JP)

(21) Appl. No.: 13/396,173

(22) Filed: Feb. 14, 2012

(30) Foreign Application Priority Data
Feb. 14, 2011 (JP) 2011-028298

(51) Int. Cl. H01M 2/06; H01M 2/00; H01M 10/04; H01M 2/30

(52) U.S. Cl. 429/7; 429/179; 29/623.1

(57) ABSTRACT

A battery includes a battery housing and a plurality of battery terminals. The battery housing has a terminal mounting portion made of resin. The battery terminals are connectible with external terminals and are mounted to the terminal mounting portion so as to extend through the terminal mounting portion, so that each of the battery terminals has a first end positioned on one side of the terminal mounting portion and a second end positioned on an opposite side of the terminal mounting portion. At least one of the battery terminals is integrated with the terminal mounting portion, so that there is no substantial clearance between the at least one of the battery terminals and a part of the terminal mounting portion, through which the at least one of the battery terminals extends.

This application claims priority to Japanese patent application serial number 2011-028298, the contents of which are incorporated herein by reference.

### BACKGROUND OF THE INVENTION

1. Field of the Invention

The present invention relates to batteries for power tools, and in particular to batteries that can be connected to power tools for use as power sources of the power sources and can be connected to battery chargers for the purpose of recharging. The present invention also relates to methods of mounting battery terminals to battery housings of the batteries.

2. Description of the Related Art

A known battery is disclosed, for example, in Japanese Laid-Open Patent Publication No. 2001-143678. As shown in FIG. 11, a battery of this publication includes a lid 110 that is a part of a battery housing. A pair of right and left guide slits 112 are formed in the lid 110 and extend in a forward and rearward direction. The guide slits 112 are configured such that plate-like terminals of a power tool or a battery charger (not shown) can be inserted into the guide slits 112 from the front side as the power tool or the battery charger is connected to the battery. A positive electrode 113 and a negative electrode 114 are connected to an electric circuit board (not shown) and are positioned on the inner side of the guide slits 112 (i.e., the inner side of the lid 110). The positive and negative electrodes 113 and 114 can be connected to the terminals of the power tool or the battery charger. A signal guide slit 117 and a connector opening 116 are formed in the lid 110 at positions between the guide slits 112. A signal electrode 115 connected to the electric circuit board is positioned on the inner side of the signal guide slit 117. The signal electrode 115 can be connected to a signal terminal of the power tool or the battery charger. A connector 119 is connected to the electric circuit board and extends outward through the connector opening 116. The connector 119 is bent to be oriented forwardly for connection with a connector (not shown) of the battery charger.

In the battery of the above publication, the positive electrode 113, the negative electrode 114, etc., are positioned between the guide slits 112 formed in the lid 110, and the connector 119 protrudes outwardly through the opening 16. Therefore, when the tool battery is wetted with water, it may be possible that the water may enter inside of the battery housing through the guide slits 112, the connector opening 116, etc.

Therefore, there has been a need in the art for a battery having a waterproof property.

### SUMMARY OF THE INVENTION

According to the present teachings, a battery includes a battery housing and a plurality of battery terminals. The battery housing has a terminal mounting portion made of resin. The battery terminals are connectible with external terminals and are mounted to the terminal mounting portion so as to extend through the terminal mounting portion, so that each of the battery terminals has a first end positioned outside of the battery housing and a second end positioned inside of the battery housing. At least one of the battery terminals is integrated with the terminal mounting portion, so that there is no substantial clearance between the at least one of the battery terminals and a part of the terminal mounting portion, through which the at least one of the battery terminals extends.

### BRIEF DESCRIPTION OF THE DRAWINGS

FIG. 1 is a perspective view as viewed from an upper side of a battery for a power tool according to a first example;

FIG. 2 is a plan view of the battery;

FIG. 3 is a vertical sectional view of the battery taken along line III-III in FIG. 2;

FIG. 4 is a vertical sectional view of the battery taken along line IV-IV in FIG. 2;

FIG. 5 is a perspective view of a lid of a battery housing of the battery as viewed from inside of the battery housing;

FIG. 6 is a perspective view of the lid similar to FIG. 5 but showing the state where an electric circuit board is mounted to an inner surface of the lid;

FIG. 7 is a schematic vertical sectional view showing a mounting structure for mounting the electric circuit board to the lid;

FIG. 8 is a schematic vertical sectional view similar to FIG. 7 but showing a mounting structure for mounting the electric circuit board to the lid according to a second example;

FIG. 9 is a schematic vertical sectional view similar to FIG. 7 but showing a mounting structure for mounting the electric circuit board to the lid according to a third example;

FIG. 10 is a schematic vertical sectional view similar to FIG. 7 but showing a mounting structure for mounting the electric circuit board to the lid according to a fourth example; and

FIG. 11 is a perspective view as viewed from an upper side of a lid of a known battery.

### DETAILED DESCRIPTION OF THE INVENTION

Each of the additional features and teachings disclosed above and below may be utilized separately or in conjunction with other features and teachings to provide improved batteries and methods of mounting battery terminals to battery housings. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings. Various examples will now be described with reference to the drawings.

In one example, a battery for a power tool is connectible with the power tool for serving as a power source for driving the power tool and is also connectible with a battery charger for recharging the battery. The battery includes a battery housing made of resin and a plurality of battery terminals extending from an outside of the battery housing into inside of the battery housing through the battery housing. The battery terminals are connectible with terminals of the power tool or terminals of the battery charger. At least one of the battery terminals is integrated with the battery housing by an insertion molding technique.

Because the at least one of the battery terminals is integrated with the battery housing by an insertion molding technique, there is no substantial clearance between the at least one battery terminal and a portion of the battery housing, through which the at least one battery terminal extend. Therefore, water may not enter inside of the battery housing from the portion of the battery housing, through which the at least one battery terminal extends.

In addition, it is not necessary to provide a seal member between the at least one battery terminal and the portion of the battery housing, through which the at least one battery terminal extends. As a result, the waterproof property can be improved without increase of the manufacturing cost.

The at least one battery terminal may include discharge or charge terminals and signal terminals.

The battery may further include an electric circuit board mounted to an inner surface of the battery housing so as to be connectible with the battery terminals. With this arrangement, it is possible to eliminate electric wires for connecting between the battery terminals and the electric circuit board.

The battery may further include a seal member provided between the electric circuit board and the battery housing and surrounding electronic components mounted to the electric circuit board. Therefore, it is possible to prevent the electric circuit board from being wetted with water.

The battery may further include a wall extending from the inner surface of the battery housing and surrounding the electric circuit board. A filling material having a waterproof property may be filled into a space inside of the wall, so that at least a part of the electric circuit board is embedded within the filling material. With this arrangement, it is possible to further reliably prevent the electric circuit board from being wetted. In addition, it is possible to improve the mounting strength of the electric circuit board to the battery housing.

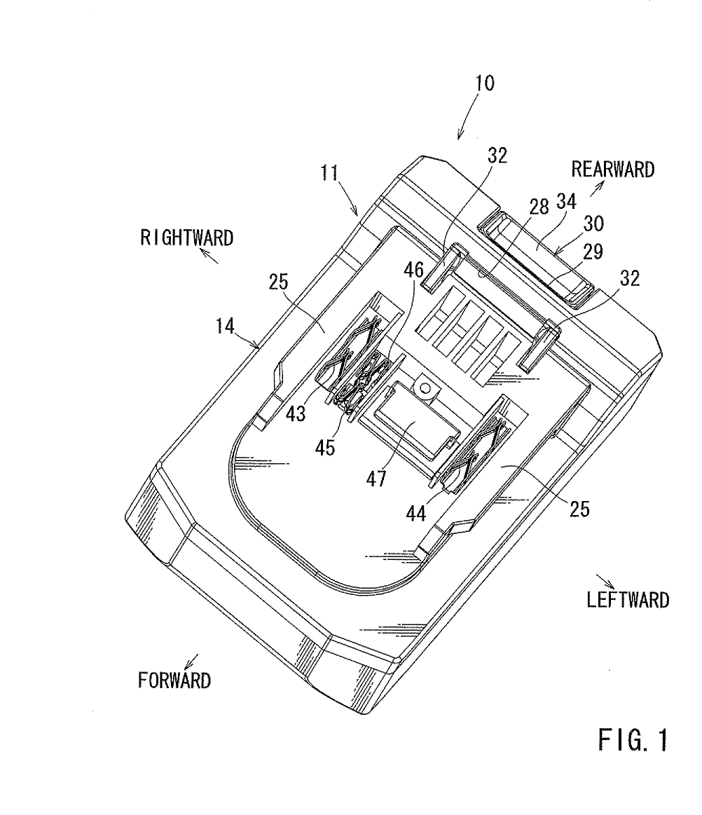

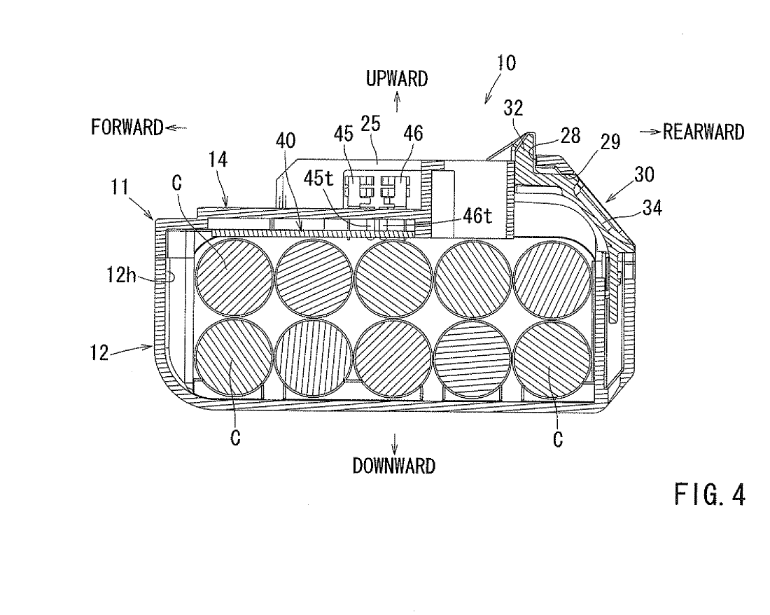

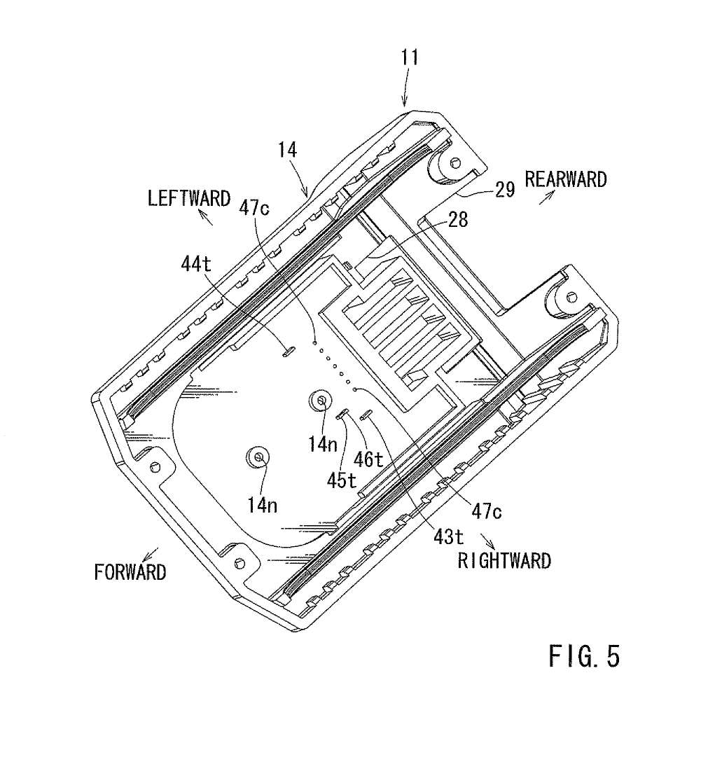

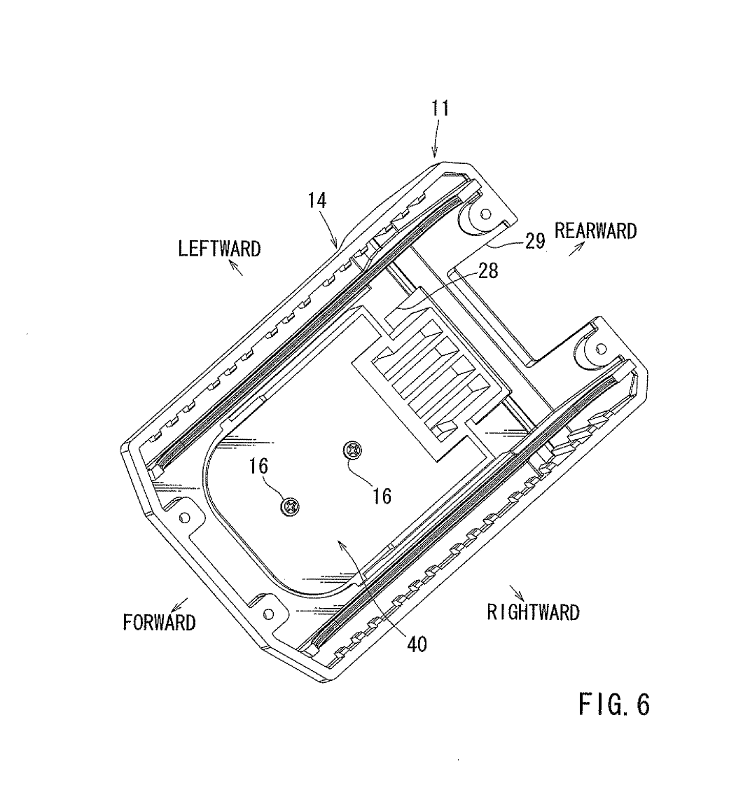

A battery according to a first example will now be described with reference to FIGS. 1 to 7. Referring to FIGS. 1 to 3, a battery 10 has a battery housing 11 defining a storage space for storing a plurality of cylindrical battery cells C. In this example, ten battery cells C are stored within the battery housing 11. The battery housing 11 includes a housing body 12 and a lid 14. The housing body 12 has an upper opening 12h (see FIG, 3) that is closed by the lid 14. Each of the housing body 12 and the lid 14 has a substantially rectangular configuration in plan view. The peripheral portion of the lid 14 (see FIG. 5) is fixed to the housing body 12 at four positions by means of screws (not shown).

The battery cells C are arranged such that their axes are parallel to the right and left direction (i.e., the widthwise direction) of the battery housing 11. More specifically, two sets of five battery cells C arranged in the forward and reward direction are vertically tiered. An electric circuit board 40 having an electric circuit (not shown) for performing a discharge control and a charge control of the battery cells C is positioned above the battery cells C.

As shown in FIG. 3, a hook member 30 having a slide lock function is disposed within the rear portion of the battery housing 11 and is biased upward by a coil spring 31, so that a pair of lock claws 32 disposed at an upper portion of the hook member 30 protrude upward from the battery housing 11. When the power tool or the battery charger has been slid on and connected to the battery 10, the lock claws 32 of the hook member 30 may engage a portion of a power tool or a battery charger (not shown) so as to prevent the power tool or the battery charge from sliding relative to the battery 10 and to hold the connecting condition between the battery 10 and the power tool or the battery charger. The lock claws 32 may be disengaged from the power tool or the battery charger when the operator pushes the hook member 30 downward against the biasing force of the coil spring 31, so that a slide lock between the battery 10 and the power tool or the battery charger can be released.

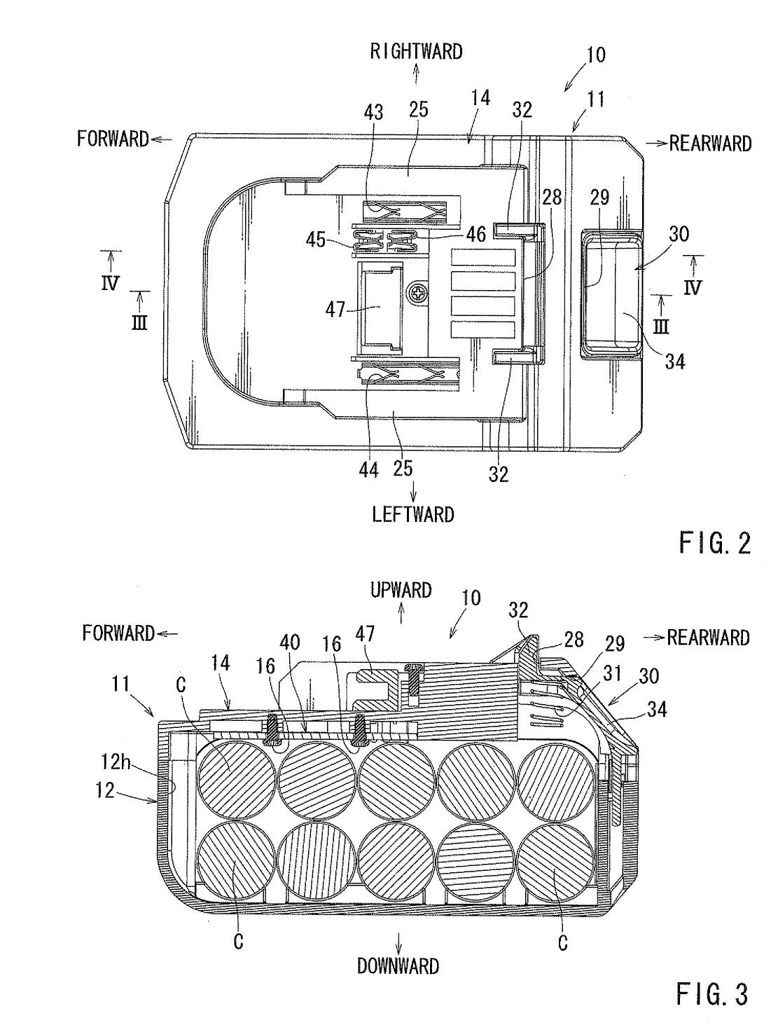

As shown in FIGS. 1 and 2, a pair of slide rails 25 are formed on the upper surface of the lid 14. The slide rails 25 are positioned on opposite sides in the right and left direction and extend in the forward and rearward direction in the parallel to each other. A positive electrode 43 and a negative electrode 44 are positioned at a central portion (with respect to the right and left direction) between the slide rails 25 on the upper surface of the lid 14. The positive and negative electrodes 43 and 44 can be electrically connected to corresponding plate-like terminals (not shown) of the power tool or the battery charger when the power tool or the battery charge is mechanically connected to the battery 10 (i.e., the lid 14). More specifically, the positive and negative electrodes 43 and 44 are disposed within the battery housing 11 such that their upper portions protrude upwardly from the upper surface of the lid 14 by a given distance so as to be exposed to the outside. Therefore, as the power tool or the battery charger moves to be slid on the battery 10 from the front side of the battery 10, the upper portions of the positive and negative electrodes 43 and 44 exposed to the outside may engage the corresponding plate-like terminals of the power tool of the battery charger so as to be electrically connected thereto. As shown in FIG. 5, a portion 43t of the positive electrode 43 and a portion 44t of the negative electrode 44 that are positioned within the battery housing 11 (positioned on the inner side or the backside of the lid 14) are electrically connected to the electric circuit board 40.

In addition, at the central portion of the upper surface of the lid 43, a first signal electrode 45 and a second signal electrode 46 are positioned on the left side of the positive electrode 43 and are arranged in line with each other in the forward and rearward direction. More specifically, the first and second signal electrodes 45 and 46 are disposed within the battery housing 11 such that their upper portions protrude upwardly from the upper surface of the lid 14 by a given distance so as to be exposed to the outside. Therefore, as the power tool or the battery charger moves to be slid on the battery 10 from the front side of the battery 10, the upper portions of the first and second signal electrodes 45 and 46 may receive corresponding signal terminals (not shown) of the power tool of the battery charger so as to be electrically connected thereto. As shown in FIG. 5, a portion 45t of the first signal electrode 45 and a portion 46t of the second signal electrode 46 that are positioned within the battery housing 11 (positioned on the inner side of the backside of the lid 14) are electrically connected to the electric circuit board 40.

Further, at the central portion of the upper surface of the lid 43, a connector 47 is positioned between the negative electrode 44 and the first and second signal electrodes 45 and 46. More specifically, the connector 47 is disposed within the battery housing 11 such that its upper portion protrudes upwardly from the upper surface of the lid 14 by a given distance so as to be exposed to the outside. Therefore, as the battery charger moves to be slid on the battery 10 from the front side of the battery 10, the upper portion of the connector 47 may be electrically connected to a corresponding connector (not shown) of the battery charger. As shown in FIG. 5, a conductor portion 47c of connector 47 that is positioned within the battery housing 11 (positioned on the inner side of the backside of the lid 14) is electrically connected to the electric circuit board 40.

Here, during a resin molding process of the lid 14, the connector 47, the positive electrode 43, the negative electrode 44, the first signal electrode 45 and the second signal electrode 46 (hereinafter called “battery terminals”) are set within a mold that is used for molding the lid 14. With the battery terminals set within the mold, a resin is injected into the mold to form the lid 14. Therefore, the battery terminals are integrated with the lid 14 at the same time the lid 14 is molded. Thus, the battery terminals are integrated with the lid 14 by an insertion molding process. The positive and negative electrodes 43 and 44 may serves as discharge or charge terminals. The first and second signal electrodes 45 and 46 may serve as signal terminals.

As shown in FIGS. 1 and 2, a claw opening 28 is formed in the rear portion of the lid 14 at a position on the rear side of the slide rails 25. As viewed in a plan view, the claw opening 28 includes a straight portion extending in the right and left direction and a pair of leg portions extending in the forward direction from opposite ends of the straight portion. The lock claws 32 of the hook member 30 extend from within the battery housing 11 upwardly of the lid 14 through the claw opening 28. A rectangular notch-like opening 29 is formed in the rear portion of the lid 14 at a position on the rear side of the claw opening 28. The hook member 30 has an operation portion 34 that protrudes upwardly from the lid 14 through the opening 29.

As described previously, the electric circuit board 40 has the electric circuit for performing a discharge control and a charge control of the battery cells C. The electric circuit may include a microcomputer and any other electronic elements necessary for the control. In addition, the electric circuit board 40 can be connect to the battery terminals including the connector 47, the positive electrode 43, the negative electrode 44, the first signal electrode 45 and the second signal electrode 46. As described previously, the battery terminals are integrated with the lid 14. Therefore, the electric circuit board 40 is mounted to the inner surface (backside surface) of the lid 14 at a predetermine position that enables the electric circuit board 40 to be directly connected to the battery terminals. More specifically, as shown in FIG. 5, two bottomed threaded holes 14n are formed in the inner surface (backside surface) of the lid 14 at positions spaced from each other in the forward and rearward direction. Screws 16 are inserted into corresponding insertion holes (not shown) formed in the electric circuit board 40 and are engaged with the threaded holes 14n, so that the electric circuit board 40 is fixed in position relative to the inner surface of the lid 14.

As shown in FIG. 7, a seal material 51 that may be an electrically insulating adhesive material is applied onto the upper surface of the electric circuit board 40 and is solidified thereon to cover a region where the microcomputer and any other electronic elements are mounted. The seal material 51 may be applied after the electric circuit board 40 has been electrically connected to the battery terminals.

According to the battery 10 of this example, the battery terminals including the connector 47, the positive electrode 43, the negative electrode 44, the first signal electrode 45 and the second signal electrode 46 are integrated with the lid 14 by an insertion molding technique. Therefore, even in the case that the battery terminals extend through the lid 14 from its outer side to the inner side (backside), no substantial clearance may be provided between the battery terminals and portions of the lid 14 through which the battery terminals extend. More specifically, each of the battery terminals closely contacts with an inner wall of each of holes of the lid 14 formed to receive the battery terminals. As a result, water may not flow through the holes of the lid 14 toward the inner side (backside) of the lid 14.

Further, because the battery terminals are integrated with the lid 14, no seal member is necessary provided between the battery terminals and portions of the lid 14 through which the battery terminals extend. Therefore, the waterproof property of the battery 10 can be improved without increase of the cost, which may be caused if seal members are provided.

Furthermore, the electric circuit board 40 is mounted to the inner surface (backside surface) of the lid 14 and is fixed at a position that enables the battery terminals to be directly connected to the electric circuit board 40. Therefore, there is no need of providing electric wires for connecting between the electric circuit board 40 and the battery terminals.

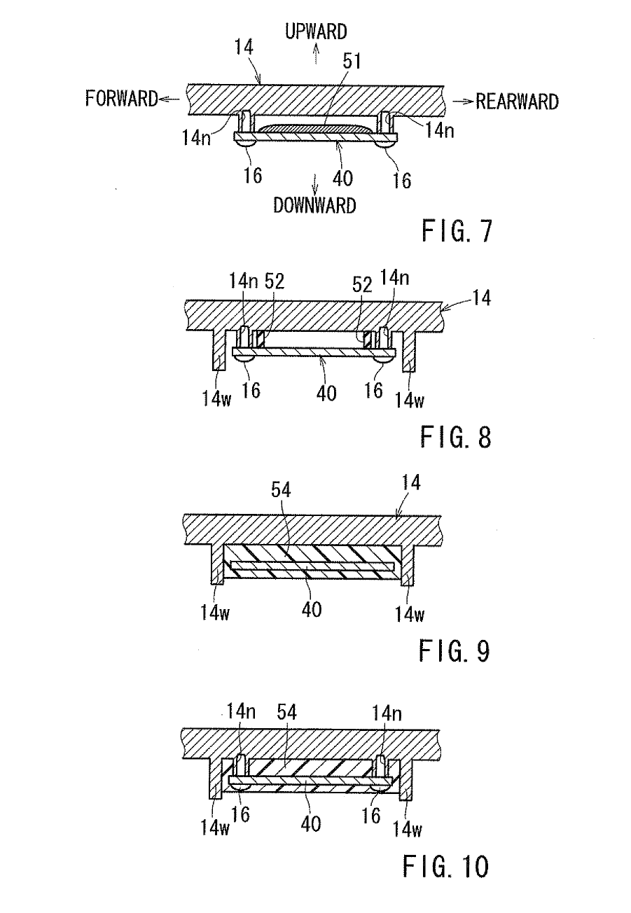

A second example will now be described with reference to FIG. 8. The second example is a modification of the first example and is different from the first example only in the mounting structure for mounting the electric circuit board 40 to the inner surface of the lid 14. Therefore, FIG. 8 shows only the mounting structure of the electric circuit board 40.

As shown in FIG. 8, a wall 14w extends vertically downward from the inner surface (backside surface) of the lid 14 and is configured to surround the electric circuit board 40 like a loop. The wall 14w has a vertical height to have a lower end positioned downwardly of the electric circuit board 40. In the state that the electric circuit board 40 is positioned inside of the wall 14w, the electric circuit board 40 is fixed in position relative to the inner side (backside) of the lid 14 by means of the screws 16 that are engaged with the threaded holes 14n in the same manner as the first example.

Further, in the second example, a ring-shaped seal member 52 is provided between the upper surface of the electric circuit board 40 and the inner surface (backside surface) of the lid 14, so that the seal member 52 surrounds the microcomputer and any other electronic elements of the electric circuit board 40.

The wall 14w surrounding the electric circuit board 40 may prevent water from reaching to the electric circuit board 40 along the inner surface of the lid 14 even in the event that water enters to the inner side (backside) of the lid 14. In addition, because the seal member 52 surrounds the microcomputer and any other electronic elements of the electric circuit board 40, it is possible to further reliably prevent water from reaching to the electric elements of the electric circuit board 40.

A third example will now be described with reference to FIG. 9. Also, the third example is a modification of the first example and is different from the first example only in the mounting structure for mounting the electric circuit board 40 to the backside surface of the lid 14. Therefore, FIG. 9 shows only the mounting structure of the electric circuit board 40.

In the third example, as in the second example, the wall 14w surrounds the electric circuit board 40 like a loop and extends vertically downward from the inner surface (backside surface) of the lid 14. In this example, the screws 16 for fixing the electric circuit board 40 in position relative to the inner side surface of the lid 14 are eliminated. Instead, a filing material 54 is filled into a space that is surrounded by the wall 14w, so that the entire electric circuit board 40 is embedded within the filling material 54. The filling material 54 may be an adhesive material having an electrical insulation property and a water-proof property.

Therefore, the electric circuit board 40 can be further reliably prevented from being wetted with water, and it is possible to further firmly fix the electric circuit board 40 in position relative to the inner surface (backside surface) of the lid 14 without need of screws 16 that fix the electric circuit board 40 to the inner surface of the lid 14.

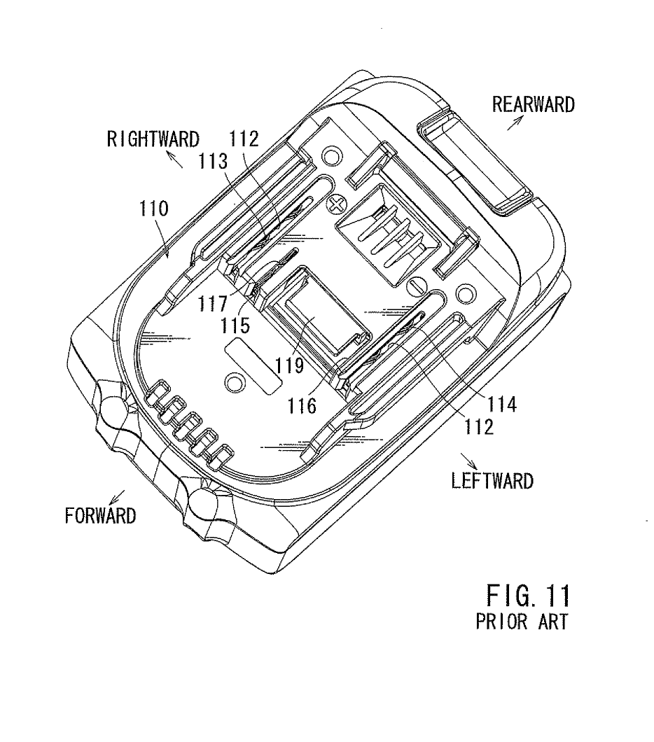

A fourth example will now be described with reference to FIG. 10. This example is a modification of the third example and is different from the third example in that the electric circuit board 40 are mounted to the inner surface of the lid 14 by using the screws 16 in addition to the filling material 54. In this example, the screws 16 are also embedded within the filling material 54.

The above examples may be modified in various ways. For example, although the battery terminals are directly electrically connected to the electric circuit board 40 in the above examples, it may be possible to electrically connect the battery terminals to the electric circuit board 40 by using lead wires.

Further, although all of the battery terminals are integrated with the lid 14 by the insertion molding technique in the above examples, it may be possible to integrate only some of the battery terminals are integrated with the lid 14. For example, only the positive electrode 43 and the negative electrode 44 positioned on the outer side with respect to the widthwise direction may be integrated with the lid 14.

What is claimed is:

1. A battery for a power tool, the battery being connectible with the power tool for serving as a power source for driving the power tool and being connectible with a battery charger for recharging the battery, comprising:
a battery housing made of resin and having a terminal mounting portion; and
a plurality of battery terminals mounted to the terminal mounting portion and extending from an outside of the battery housing into inside of the battery housing through the battery housing,
wherein the battery terminals are connectible with terminals of the power tool or terminals of the battery charger; and
wherein the at least one of the battery terminals is integrated with the terminal mounting portion by using an insertion molding technique.

2. The battery as in claim 1, wherein there is no substantial clearance between the at least one of the battery terminals and a part of the terminal mounting portion, through which the at least one of the battery terminals extends.

3. The battery as in claim 1, wherein the battery terminals include discharge or charge terminals and signal terminals.

4. The battery as in claim 1, further comprising an electric circuit board fixedly mounted to an inner surface of the terminal mounting portion so as to be connectible with the battery terminals.

5. The battery as in claim 4, further comprising a seal member provided between the electric circuit board and the terminal mounting portion and surrounding electronic components mounted to the electric circuit board.

6. The battery as in claim 5, further comprising a wall extending from the inner surface of the terminal mounting portion and surrounding the electric circuit board.

7. The battery as in claim 6, further comprising a filling material having a waterproof property and filled into a space defined inside of the wall, so that at least a part of the electric circuit board is embedded within the filling material.

8. The battery as in claim 1, wherein the battery housing includes a housing body having an open side and a lid mounted to the housing body for closing the open side, and the lid includes the terminal mounting portion.

9. A battery comprising:
a battery housing having a terminal mounting portion made of resin; and
a plurality of battery terminals connectible with external terminals and mounted to the terminal mounting portion so as to extend through the terminal mounting portion, so that each of the battery terminals has a first end positioned on the outer side of the battery housing and a second end positioned on the inner side of the battery housing;
wherein at least one of the battery terminals is integrated with the terminal mounting portion, so that there is no substantial clearance between the at least one of the battery terminals and a part of the terminal mounting portion, through which the at least one of the battery terminals extends.

10. The battery as in claim 9, wherein the at least one of the battery terminals is integrated with the terminal mounting portion by using an insertion molding technique.

11. The battery as in claim 9, further comprising an electric circuit board disposed inside of the battery housing and directly electrically connected to the second ends of the battery terminals.

12. A method of mounting at least one battery terminal to a terminal mounting portion of a battery housing of a battery, comprising:
integrating the at least one battery terminal with the terminal mounting portion by using an insertion molding technique, so that the at least one battery terminal extends through the terminal mounting portion, the at least one battery terminal having a first end positioned outside of the battery housing and a second end positioned inside of the battery housing.
